(19) United States
(12) Patent Application Publication
(10) Pub. No.: US 2006/0184319 A1
(43) Pub. Date: Aug. 17, 2006

(54) Navigational aid for emergency vehicles

(76) Inventors: Ryan E. Seick, Palatine, IL (US); Carolyn M. Gofron, Palatine, IL (US); Vijay S. Raisinghani, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/059,893

(22) Filed: Feb. 17, 2005

(51) Int. Cl. G01C 21/34

(52) U.S. Cl. 701/209; 340/995.19

(57) ABSTRACT

A method for aiding emergency vehicle navigation includes a first step (100) of calculating a travel route for the emergency vehicle from a starting point to a destination point. A next step (102) includes establishing a location of any non-emergency vehicle in proximity to the emergency vehicle. A next step (104) includes determining a likelihood of the non-emergency vehicle and emergency vehicle encountering each other. A next step (106) includes providing navigational information to the non-emergency vehicle to re-route the non-emergency vehicle out of the path of the emergency vehicle if the vehicles are likely to encounter each other. Likelihood can be based on whether the vehicles are on the same navigational road segment or by a time or distance when the vehicles will intercept each other.

### FIELD OF THE INVENTION

The present invention relates to emergency vehicle navigation, and more particularly to a system that aids emergency vehicles in their navigation through non-emergency vehicles.

### BACKGROUND OF THE DISCLOSURE

Emergency vehicles, such as ambulances, fire engines, police cars, and so on, can pose hazards to other vehicles on the roads. While traveling to and from scenes of emergencies, emergency vehicles have been involved in accidents with other vehicles or have caused other vehicles to have accidents. There have been prior attempts to increase the safety of the operation of emergency vehicles while traveling to and from scenes of emergencies.

One solution is to equip an emergency vehicle with a GPS receiver. Equipment in the emergency vehicle uses the GPS receiver to determine the emergency vehicle's location and heading. Data indicating the emergency vehicle's location and heading are transmitted from the emergency vehicle to intersection controllers that are located at each intersection that has traffic signals. The intersection controller uses the data indicating the emergency vehicle position and heading to determine whether the emergency vehicle is on any road that might lead to the intersection. If the emergency vehicle is on any road heading toward an intersection, the intersection controller operates the traffic signals at the intersection to give the emergency vehicle the right-of-way. However, this does not address any of the other traffic on the roadway, which can still result in safety problems.

Another solution is to warn any non-emergency vehicles in proximity to the emergency vehicle. This warning constitutes a radio frequency transmission, to non-emergency vehicles so equipped, that there is an emergency vehicle close by. However, this solution provides no more than a warning. In addition, this system will needlessly warn drivers of a nearby emergency vehicle even when that vehicle is traveling away from them and poses no safety threat What is needed is system to predict the path of an emergency vehicle, and to provide further direction to non-emergency vehicles so that safety is improved along the path.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a plan view of a roadway network, utilized in accordance with the present invention;

FIG. 2 shows a block diagram of a navigational aid system, in accordance with the present invention; and

FIG. 3 shows a flow chart of a method, in accordance with the present invention.

### DETAILED DESCRIPTION OF EMBODIMENTS OF THE INVENTION

The present invention describes a method and system to predict the path of an emergency vehicle, and to provide further direction to non-emergency vehicles so that safety is improved along the path.

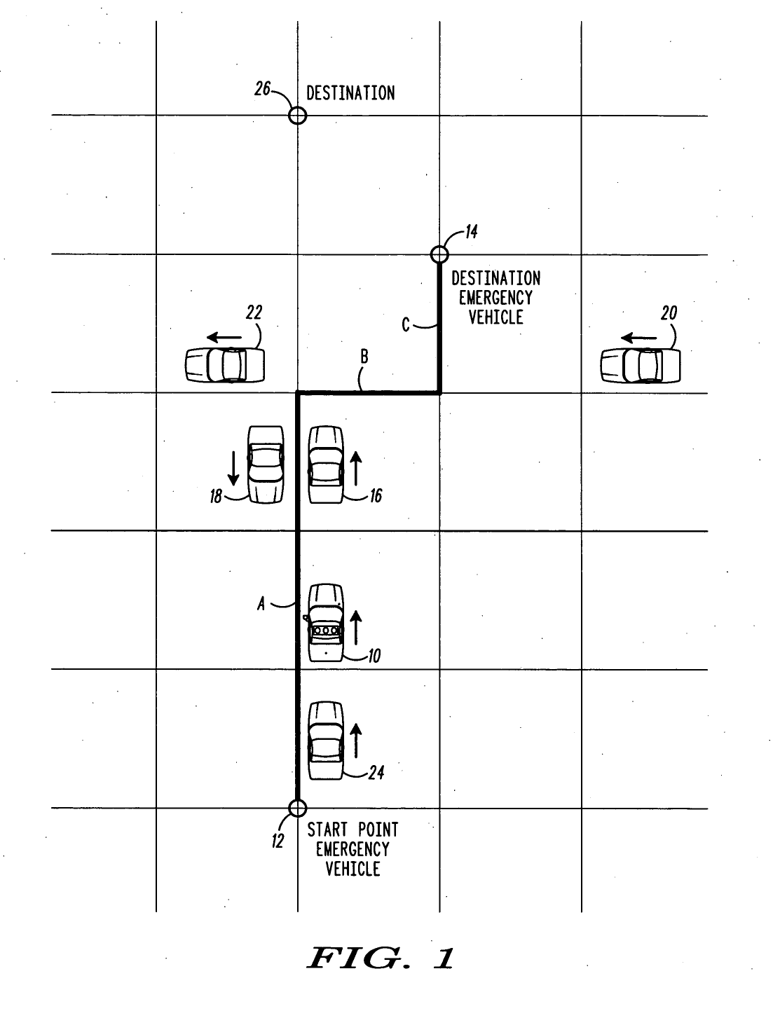

FIG. 1 shows a map of a network of roads and intersections. Traffic on the roads and intersections is controlled by traffic control signals, such as stop signs, traffic lights, directional signs, speed limit signs, etc. The present invention is concerned about the presence of an emergency vehicle 10 on the road network and its interaction with other non-emergency vehicles 16, 18, 20, 22, 24 on the roadway. The emergency vehicle 10 can be any type of emergency vehicle, such as a fire truck, police car, ambulance, or any other type of emergency vehicle. In the example shown, the emergency vehicle 10 is traveling from a start point 12 to a destination point 14. The route of travel is preplanned along road segments (A, B, C) from the start point 12 to the destination point 14. The destination point can be the scene of an emergency (e.g. fire, accident) and the starting point can be the location from where the emergency vehicle begins its trip (e.g. fire house, hospital) to the scene of the emergency. The route itself consists of a series of connected road segments (A, B, C) over which the emergency vehicle can travel from the start point to the destination. The preplanned route can be a route that was planned by a navigational system, as are known in the art, or entered by a dispatcher of the emergency vehicle or other user of the emergency vehicle or system.

Other, non-emergency vehicles 16, 18, 20, 22, 24 are also located on the road network. These other vehicles can include private passenger cars, business or commercial vehicles such as trucks, public passenger vehicles such as busses, or any other non-emergency vehicle. As shown there is a first vehicle 16 traveling along the emergency route, on segment A, away from the emergency vehicle. A second vehicle 18 and a fifth vehicle 24 are also traveling along the emergency route, on segment A, but towards the emergency vehicle. A third vehicle 20 is not on the emergency route, but is traveling towards the emergency route. A fourth vehicle 22 is not on the emergency route, and is traveling away from the emergency route.

The present invention provides re-routing directions to the non-emergency vehicles, as needed, such that these vehicles leave the route of the emergency vehicle to clear the way for the emergency vehicle 10. The re-routing aids the navigation of the emergency vehicle by eliminating traffic in the path of the emergency vehicle and reducing risk of collision with or between non-emergency vehicles, thereby improving safety. Preferably, the non-emergency vehicles are equipped with radio telecommunications equipment (i.e. cellular telephone service), and more preferably location and navigational assistance equipment, as are known in the art, such that the non-emergency vehicles are able to receive and utilize the re-routing directions. Otherwise, the drivers of the non-emergency vehicles can only respond to the warning signals (i.e. lights and sirens) of the emergency vehicle upon perception by the driver in the normal manner.

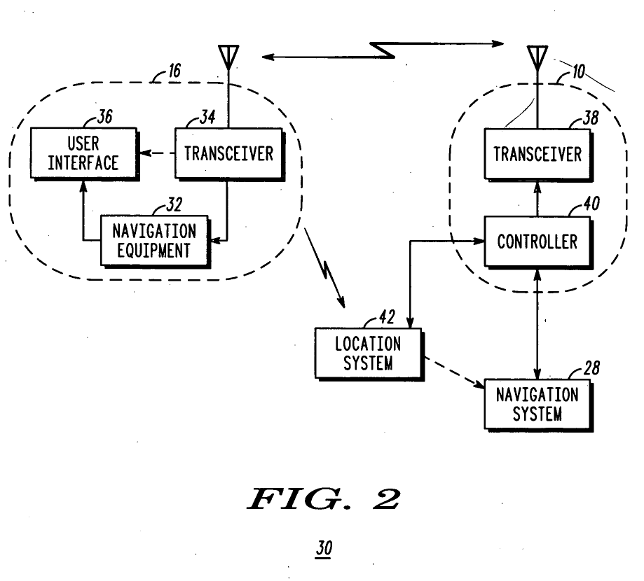

Any re-routing instructions provided by the present invention are predicated on the predicted interaction of the emergency vehicle with non-emergency vehicles. There are several scenarios to consider. However, the scenarios all share common elements. Referring to FIGS. 1 and 2, the present invention for aiding emergency vehicle navigation provides a navigation system 28 operable to calculate a travel route for the emergency vehicle from a starting point to a destination point. The navigation system can be a remote system, such as one located at an emergency dispatch center, or it can be located within the emergency vehicle itself 10. The navigation system includes a geographic database that includes information about the network of roads and intersections, traffic signals, speed limits, one-ways streets and the like that affect the movement of traffic. The navigation system can calculate a route for the emergency vehicle along the road network, given a defined start point and a destination.

A location system 42 is operable to establish a location of the emergency vehicle, and any non-emergency vehicle in proximity to the emergency vehicle, relative to the road network. For example, the vehicles may have navigation equipment 32 that can include Global Positioning System (GPS) capabilities that can determine a position of the vehicles 10, 16 and relate these to the location system 42, either directly or through other telecommunication means (i.e. through transceiver 34, transceiver 38, controller 40). Alternatively, triangulation and/or time-of-arrival of radio communication signals, and other known indirect positioning systems could be used to determine location and possibly movement, as are known in the art. The location system 42 can be directly tied to the navigational system 28. The navigation and locations systems include hardware and software components, as are known in the art, and can include their own separate processors, data storage, user interfaces, etc. Preferably, the location system includes a vehicle tracking application that is used to periodically track the location of the emergency vehicle in relation to the non-emergency vehicles in proximity thereto.

A controller 40 is operable to communicate with the navigation system 28 and the location system 42. The controller can be a controller existing in the dispatch center or in the emergency vehicle (as shown). Alternatively, the controller can be incorporated with one or both of the navigation system 28 and location system 42. The controller determines a likelihood of the non-emergency vehicle and emergency vehicle encountering each other and provides navigational information from the navigation system 28 to the non-emergency vehicle 16 to re-route the non-emergency vehicle out of the path of the emergency vehicle if the vehicles are likely to encounter each other. The re-routing information can be a simple visual or audible indication on a user interface 36 of the identified vehicle, or can implement a change in the pre-planned route of the vehicle 16, under emergency authority, if the vehicle has navigational equipment installed therein with the appropriate capabilities programmed therein. The user interface can include an audible alert, a speaker for vocal warning, a text display such as on a RDS equipped radio, a head-up display, a navigational display, and the like. The user interface would be programmed to respond to emergency re-route messages, in accordance with the present invention.

The likelihood of the vehicles encountering each other depends their relative location and movement. The emergency vehicle could periodically send its location, direction, and the like to the controller and/or navigation system. The movement of all non-emergency vehicles may not be known unless those vehicles have navigational equipment 32 or locational equipment aboard. Vehicles equipped in this manner could periodically transmit to the navigation system 28 the location of the vehicle. In addition, direction, speed, etc. could also be transmitted. Given a location and movement (velocity) of each vehicle, it is possible for the controller to estimate when and where the vehicles are likely to encounter each other. Due to practical considerations, it is only necessary to calculate encounter possibilities with those vehicles that are proximal in location to the emergency vehicle. Not only does this lessen the amount of calculations needed, it improves the accuracy of the encounter predictions by taking into account the changing movements of each vehicle. Of course, the encounter predictions are improved by determining the velocity of nearby vehicles periodically.

In one embodiment, the likelihood of an encounter is based on a predetermined time limit before the vehicles encounter each other. For example, if a non-emergency vehicle 16 is far ahead of the emergency vehicle 10, and traveling at the same or faster speed, it is likely that the vehicles will not meet within the predetermined time. In this case, re-routing instructions will not be provided to the non-emergency vehicle 16. However, it is more likely the case that the emergency vehicle 10 will be approaching the non-emergency vehicle 16 from behind. In this case, if the emergency vehicle is likely to encounter the non-emergency vehicle 16 within the predetermined time (e.g. two minutes), then re-routing instructions can be issued to the non-emergency vehicle 16.

The re-routing instructions can be a simple text instruction giving driving directions, such as “turn left at the next intersection”. This would be sufficient to clear the emergency route of the non-emergency vehicle. However, this can be inconvenient to the driver of the non-emergency vehicle. Therefore, it is preferred to provide re-routing instructions that will send the non-emergency vehicle along the same direction (e.g. turn left at next intersection and right at the following intersection) or to return to the same route (e.g. turn left at next intersection, right at the following intersection, right at the following intersection, and left at the following intersection). More preferably, if the controller determines that the non-emergency vehicle has its own navigation equipment 32 with a preplanned route and destination point programmed therein, then the navigation system 28 can take that destination point 26 into account and provide re-routing instructions for the controller to relay to suit the destination point 26 of the non-emergency vehicle 16 (i.e. continue traveling straight at the next intersection). Given any number of non-emergency vehicles, the navigation system can provide different re-routing instructions to each non-emergency vehicle, to prevent clogging of any particular roadway.

In another embodiment, the navigation system can just determine the location of those vehicles that are on the present or next road segment (A, B, C), without consideration of timing. The navigation system is operable to calculate the emergency vehicle travel route in route segments, and the location system is operable to determine whether the non-emergency vehicle is traveling on the same or next route segment as the emergency vehicle. In this case, a location is only needed and not a direction. Any vehicle 16, 18, 24 on the same or next navigational road segment (A, B) as the emergency vehicle 10 can be issued re-routing instructions. Again, although this is effective in clearing the route, it may be inconvenient or unnecessary for particular vehicles. Therefore, it would be desirable to obtain directional information for the non-emergency vehicles on the present or next route segment. For example, vehicle 24 is behind the emergency vehicle and provides no obstacle, even though traveling in the same direction, so re-routing instructions need not be provided thereto. Similarly, vehicle 18 is on the other side of the road traveling towards the emergency vehicle 10. In this case, a simple warning to move over would be sufficient and no re-routing instructions would be needed. Only vehicle 16 which is in the way of the emergency vehicle need be issued re-routing instructions. In this case, the controller 40 provides navigational information from the navigation system 28 to the non-emergency vehicle 16 to re-route the non-emergency vehicle out of the path of the emergency vehicle if the non-emergency vehicle is traveling on the same or next route segment (A, B). As before, any existing navigational information or destination point 26 of the non-emergency vehicle 16 can be taken into account when re-routing the non-emergency vehicle 16.

There will also be occurrences of vehicles 20, 22 in proximity to the emergency route and/or the emergency vehicle that may be heading towards the route or emergency vehicle while not traveling on the actual route. In this case, the likelihood of an encounter can again be based on a predetermined time limit before the vehicles in proximity to the emergency vehicle encounter the emergency vehicle. For example, if a non-emergency vehicle 22 is near the emergency route but traveling away from the route, it is likely that the vehicles will not meet within the predetermined time if at all, event though it is in proximity to the route or emergency vehicle. In this case, re-routing instructions will not be provided to the non-emergency vehicle 22. However, vehicle 20 may indeed encounter the emergency vehicle when it is traveling on route segment B. In this case, if the emergency vehicle is likely to encounter the non-emergency vehicle 16 within the predetermined time (e.g. two minutes) or location, then re-routing instructions can be issued to the non-emergency vehicle 20. In addition, if the controller determines that the non-emergency vehicle 20 has its own navigation equipment 32 with a preplanned route programmed therein, then the navigation system 28 can direct the navigation equipment 32 to take notice that the area, route segments, or intersections being approached (B,C) are closed and re-route the vehicle 20 away these segments (i.e. a virtual road closure or temporary road block). Such notice can include marking that vehicle's route as an emergency route on the user interface 36 of that vehicle, such as by providing a visual warning (e.g. marking the route red) or providing an audible warning.

The present invention would also find application after the emergency vehicle 10 arrives at its intended destination point 14, such as when an emergency vehicle arrives at an accident or fire for example. In this case, it is still desirable to re-route non-emergency vehicles away from the scene, for the sake of safety and to allow access by other emergency vehicles. By re-routing vehicles that may encounter the scene of an accident, this present invention solves many problems of traffic and safety concerns. Traffic will lighten around the emergency area in order to let the emergency be resolved in a safer environment. This will also allow for any other vehicles that may need to get to the scene of the accident, i.e. tow trucks, an easier, less congested route. It will also fulfill the needs of those traveling on the roads so they do not run the risk of getting delayed. In this scenario, as before the likelihood of an encounter is based on a proximity of non-emergency vehicles to the emergency vehicle, and a predetermined time limit before the vehicles encounter each other. For example, if a non-emergency vehicle 16 is behind the destination point 14 of the emergency vehicle, it is likely that the vehicles will meet. Of course, it may be the case that the non-emergency vehicle may not reach the destination point for quite some time. Therefore, a predetermined time limit can be used (e.g. fifteen minutes), wherein the non-emergency vehicle will not be re-routed until it is within the predetermined time limit for reaching the emergency. In this case, unnecessary re-routing instructions can be avoided until they are necessary, since the non-emergency vehicle may deviate from the route on its own accord before reaching the emergency.

Preferably, it would still be desirable to provide a warning to the non-emergency vehicle about its approach to an emergency vehicle. If the non-emergency vehicle has navigational equipment, the present invention would send navigational information to non-emergency vehicles heading into an emergency area designating that area as an emergency area or a temporary road block for vehicles. The navigational information can be received by the vehicle, and used by its navigational equipment to re-route around the locations of the accident or road closure by suggesting temporary detour paths. This will allow for emergency teams, construction crews, or tow trucks to do their job with increased safety, allowing for minimal traffic flow past the designated site.

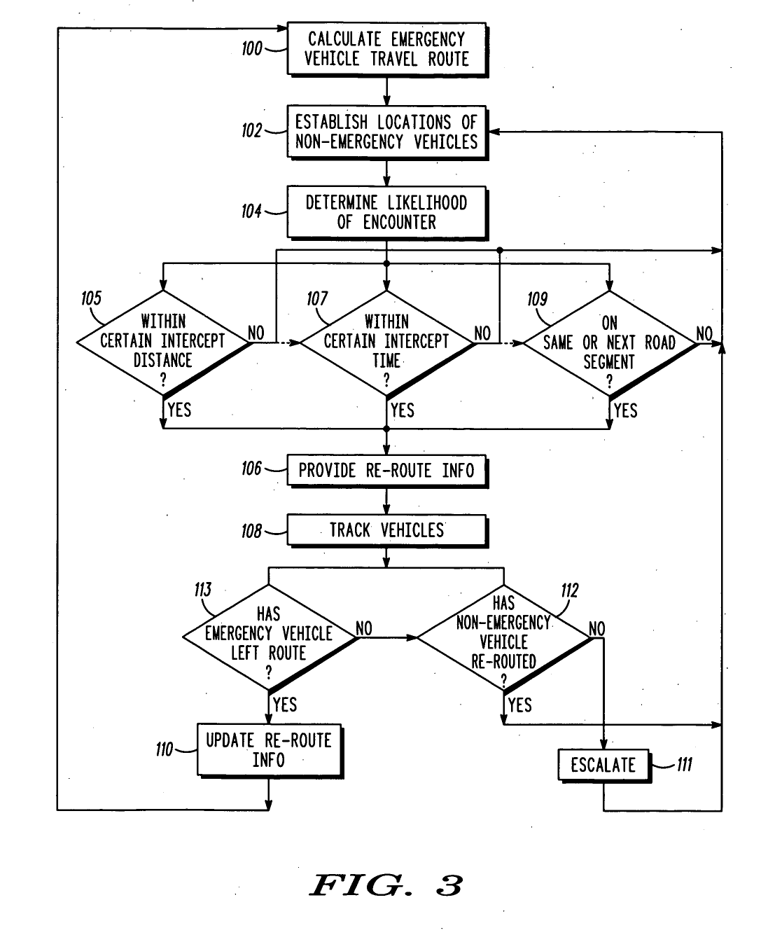

FIG. 3 is a flow chart that shows the operation of the system of FIG. 2 that includes a method for aiding emergency vehicle navigation, in accordance with the present invention. A first step 100 includes calculating a travel route for the emergency vehicle from a starting point to a destination point. This is typically performed in the navigational system that is remotely located at a dispatch center (but can be performed in the emergency vehicle itself). The dispatcher center receives information regarding a location of an emergency (destination point). The dispatcher will locate (start point) the nearest appropriate emergency response vehicle. The navigation system will calculate the travel route (e.g. a series of route segments) for the emergency vehicle using the define start point and destination and transfer the emergency route to the emergency vehicle. The emergency vehicle will then transmit back its progress (i.e. location, movement, etc.) along the route.

A next step 102 includes establishing a location of any non-emergency vehicle in proximity to the emergency vehicle. Proximity can established for any vehicle that is within a predetermined radius (by time or distance or both) of the emergency vehicle or emergency route. Alternatively, proximity can be determined as to whether the non-emergency vehicle is located on the present or next route segment of the emergency vehicle. The location system is linked to the navigation system and controller. Optionally, one or more of the controller navigation system, and location system can be incorporated together. The location system can operate periodically to dynamically establish any vehicle location, and specifically by requesting location information from non-emergency vehicles.

A next step 104 includes determining a likelihood of the non-emergency vehicle and emergency vehicle encountering (i.e. intercepting) each other, as detailed above. The likelihood can be limited by distance 105, time 107, or both. Alternatively, likelihood can be based upon whether the non-emergency vehicle is located on the present or next route segment 109 of the emergency vehicle. The likelihood can be used in the case of: a) the emergency vehicle approaching a non-emergency vehicle that is ahead of the emergency vehicle (and possibly in the same direction), b) a non-emergency vehicle approaching a moving or stopped emergency vehicle from behind, and c) a non-emergency vehicle that can intersect the emergency vehicle or its route. This step 104 can operate periodically to dynamically establish an encounter likelihood between the emergency and non-emergency vehicles.

In any of the above instances, a next step 106 can include providing navigational information to the non-emergency vehicle to re-route the non-emergency vehicle away from the emergency vehicle if the vehicles are likely to encounter each other. Further, the re-routing information can take into account the ultimate destination of the emergency vehicle, routing the non-emergency vehicle away from the destination. This step 106 can be limited by providing re-routing information only when the vehicles are within a predetermined time limit before the encountering each other, or whether the non-emergency vehicle is located on the present or next route segment of the emergency vehicle. Specifically the predetermined time limits can be different depending upon whether the emergency vehicle is being approached by a non-emergency vehicle or whether the emergency vehicle is approaching a non-emergency vehicle. Preferably, a warning is also provided to a driver of the non-emergency vehicle of the proximity of the emergency vehicle and the need to re-route the non-emergency vehicle. This can be provided on a user interface of the vehicle. Optionally, this step 106 can include determining whether the non-emergency vehicle is operating on a navigational system defining a destination point of the non-emergency vehicle, wherein the re-routing information takes into account the destination point of the non-emergency vehicle.

A further step 108 can be included of tracking the non-emergency vehicle, wherein if the non-emergency does not respond to the re-routing instruction 112, the providing step can be repeated to provide an escalating warning 111. For example, the user interface of the targeted non-emergency vehicle can first provide a visual warning and display new navigational data for the re-route. If the driver does not respond within a predetermined time, an audible alert can be added to the visual warning. Escalation can continue using various techniques up to and include a citation for a traffic violation.

This step can also include periodic tracking of the emergency vehicle 113. Since the emergency vehicle may depart from the intended emergency route, it is desirable that the present invention operate dynamically to account for these changes. The emergency vehicle may depart from emergency route for a number of reasons. For example, the emergency vehicle driver has the discretion to use different routes, as needed. In addition, the calculated route may be blocked by traffic or other unforeseen event. In any event, if the location/navigation system detects that the emergency vehicle has departed from the emergency route, the above steps will be repeated for all vehicles. When the emergency vehicle departs from its route, the departure point is used as a new start point for emergency route calculation. The destination point remains the same. Then, the steps are repeated. There can be a further update step 110 for the re-routing information that can include canceling re-routing instructions issued to particular non-emergency vehicles, as needed, providing new re-routing instructions to previously warned and newly-warned non-emergency vehicle, and providing a warning, as needed.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method for aiding emergency vehicle navigation, the method comprising the steps of:
calculating a travel route for the emergency vehicle from a starting point to a destination point;
establishing a location of any non-emergency vehicle in proximity to the emergency vehicle;
determining a likelihood of the non-emergency vehicle and emergency vehicle encountering each other; and
providing navigational information to the non-emergency vehicle to re-route the non-emergency vehicle away from the emergency vehicle if the vehicles are likely to encounter each other.

2. The method of claim 1, wherein the providing step occurs within a predetermined time limit before the vehicles encounter each other.

3. The method of claim 1, wherein the calculating step includes calculating the emergency vehicle travel route in route segments, and the determining step include determining whether the non-emergency vehicle is traveling on a next route segment of the emergency vehicle, wherein the providing step occurs if the non-emergency vehicle is traveling on the next route segment of the emergency vehicle.

4. The method of claim 1, wherein the providing step also includes determining whether the non-emergency vehicle is operating on a navigational system defining a destination point of the non-emergency vehicle, wherein the re-routing information takes into account the destination point of the non-emergency vehicle.

5. The method of claim 1, wherein the establishing and determining steps are performed periodically to dynamically track and re-route non-emergency vehicles.

6. A method for aiding emergency vehicle navigation, the method comprising the steps of:
calculating a travel route for the emergency vehicle from a starting point to a destination point;
establishing a location of any non-emergency vehicle in proximity to the emergency vehicle;
determining whether the non-emergency vehicle is traveling on the route of the emergency vehicle; and
providing navigational information to the non-emergency vehicle to re-route the non-emergency vehicle out of the path of the emergency vehicle.

7. The method of claim 6, wherein the determining step include determining when the emergency vehicle and the non-emergency vehicle will intercept each other, and wherein the providing step occurs within a predetermined time limit before the interception.

8. The method of claim 6, wherein the calculating step includes calculating the emergency vehicle travel route in route segments, and the determining step include determining whether the non-emergency vehicle is traveling on a next route segment of the emergency vehicle, wherein the providing step occurs if the non-emergency vehicle is traveling on the next route segment of the emergency vehicle.

9. The method of claim 6, further comprising the steps of tracking the vehicles and updating the re-routing information.

10. The method of claim 6, wherein the determining step includes determining whether the non-emergency vehicle is traveling on the route ahead of the emergency vehicle.

11. The method of claim 6, wherein the determining step includes determining whether the non-emergency vehicle is traveling on the route ahead of the emergency vehicle and when the emergency vehicle and the non-emergency vehicle will intercept each other, and wherein the providing step occurs within a predetermined time limit before the interception.

12. The method of claim 6, wherein the determining step includes determining whether the non-emergency vehicle is traveling on the route behind the emergency vehicle and when the non-emergency vehicle will intercept the emergency vehicle, and wherein the providing step occurs within a second predetermined time limit before the interception.

13. The method of claim 6, wherein the providing step also includes determining whether the non-emergency vehicle is operating on a navigational system defining a destination point of the non-emergency vehicle, wherein the re-routing information takes into account the destination point of the non-emergency vehicle.

14. The method of claim 6, wherein the establishing and determining steps are performed periodically to dynamically track and re-route non-emergency vehicles.

15. The method of claim 6, wherein the providing step includes navigational information that re-routes the non-emergency vehicle away from the destination point of the emergency vehicle.

16. The method of claim 6, wherein the determining step also includes determining whether the non-emergency vehicle is traveling towards the route of the emergency vehicle and the likelihood of the emergency vehicle and the non-emergency vehicle intercepting each other.

17. A system for aiding emergency vehicle navigation, the system comprising:
a navigation system operable to calculate a travel route for the emergency vehicle from a starting point to a destination point and a travel re-route for a non-emergency vehicle;
a location system operable to establish a location of the emergency vehicle and any non-emergency vehicle in proximity to the emergency vehicle; and
a controller operable to communicate with the navigation system and location system, wherein the controller operates to determine a likelihood of the non-emergency vehicle and emergency vehicle encountering each other and provides navigational information from the navigation system to the non-emergency vehicle to re-route the non-emergency vehicle out of the path of the emergency vehicle if the vehicles are likely to encounter each other.

18. The system of claim 17 wherein the likelihood of an encounter is based on a predetermined time limit before the vehicles encounter each other.

19. The system of claim 17, wherein the navigation system is operable to calculate the emergency vehicle travel route in route segments, and the location system is operable to determine whether the non-emergency vehicle is traveling on a next route segment as the emergency vehicle, wherein the controller provides navigational information from the navigation system to the non-emergency vehicle to re-route the non-emergency vehicle out of the path of the emergency vehicle if the non-emergency vehicle is traveling on the next route segment.

20. The system of claim 17, wherein the controller also determines whether the non-emergency vehicle is operating with navigational equipment that defines a destination point of the non-emergency vehicle, wherein the re-routing information takes into account the destination point of the non-emergency vehicle.
